(19) United States
(12) Patent Application Publication
(10) Pub. No.: US 2008/0106102 A1
(43) Pub. Date: May 8, 2008

(54) Wind-powered electricity generator

(76) Inventor: Ching-Hai Liao, Taichung (TW)

Correspondence Address: BIRCH STEWART KOLASCH & BIRCH, PO BOX 747, FALLS CHURCH, VA, 22040-0747, US

(21) Appl. No.: 11/594,184

(22) Filed: Nov. 8, 2006

(51) Int. Cl. F03D 9/00; F03D 3/02

(52) U.S. Cl. 290/55; 416/197 A; 416/179

(57) ABSTRACT

A wind-powered electricity generator has a body, an axle, a rotor, a stator and a fan assembly. The rotor is mounted inside the body. The stator is connected to the axle inside of the body. The fan assembly is connected to the body and has a wind-ladle device, a blade device and at least one covering device. The wind-ladle device is attached to the body with multiple wind ladles. The blade device is connected to the body and has a lower mounting plate, multiple blades and a middle mounting plate. The lower mounting plate is connected to the body. The blades are mounted annular between the mounting plates. The at least one covering device is connected to the blade device between the mounting plates and each has an inner coverings, an outer coverings and a spring.

### BACKGROUND OF THE INVENTION

1. Field of the Invention

The present invention relates to a wind-powered electricity generator, and more particularly to a wind-powered electricity generator with a fan assembly that can store energy in a slight wind condition and close the fan assembly automatically in a stiff wind condition.

2. Description of Related Art

A conventional wind-powered electricity generator is used to generate power by wind and comprises a body, a power package and multiple blades. The body is hollow and has an outer surface. The power package is mounted in the body. The blades are mounted rotatably on the outer surface of the body and are connected to the power package. Each blade has a leeward side and a windward side. The windward sides of the blades are smooth.

However, the conventional wind-powered electricity generator has the following shortcomings.

1. The blades are mounted outside of the body and this may cause the blades broken in a stiff wind condition. In addition, the leeward side of each blade may generate a drag force to the windward side of the blade, this will decrease the efficiency of generating power with the blades.

2. The windward side of the blade is smooth. The structure of the windward side cannot store wind to push the blades and this will decrease the rotating speed of the blades and the efficiency of the wind-powered electricity generator.

3. In general, the conventional wind-powered electricity generator needs a braking device or an electromagnetic device to slow down the rotating speed of the blades with a friction force or a magnetic force in a stiff wind to prevent the blades from being broken.

The wind-powered electricity generator in accordance with the present invention mitigates or obviates the aforementioned problems.

### SUMMARY OF THE INVENTION

The main objective of the present invention is to provide a wind-powered electricity generator that can store energy in a slight wind condition and cover the fan assembly automatically in a stiff wind condition.

The wind-powered electricity generator has a body, an axle, a rotor, a stator and a fan assembly. The rotor is mounted inside the body. The stator is connected to the axle inside of the body. The fan assembly is connected to the body and has a wind-ladle device, a blade device and at least one covering device. The wind-ladle device is attached to the body with multiple wind ladles. The blade device is connected to the body and has a lower mounting plate, multiple blades and a middle mounting plate. The lower mounting plate is connected to the body. The blades are mounted annular between the mounting plates. The at least one covering device is connected to the blade device between the mounting plates and each has an inner coverings, an outer coverings and a spring.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a wind-powered electricity generator with a fan assembly in accordance with the present invention;

FIG. 2 is a side view in partial section of the wind-powered electricity generator in FIG. 1;

FIG. 3 is a cross sectional top view of the wind-powered electricity generator along line 3-3 in FIG. 2; and

FIG. 4 is an operational cross sectional top view of the wind-powered electricity generator in FIG. 2 in a stiff wind condition.

### DETAILED DESCRIPTION OF THE PREFERRED EMBODIMENT

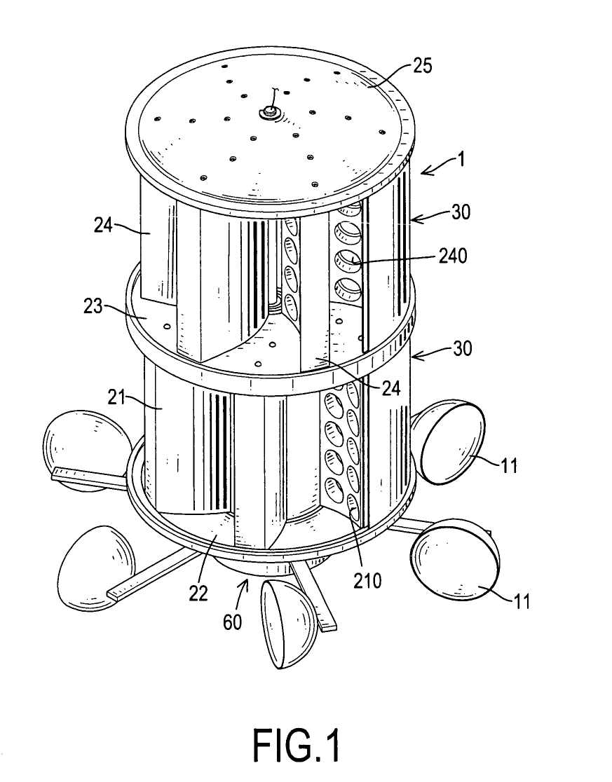

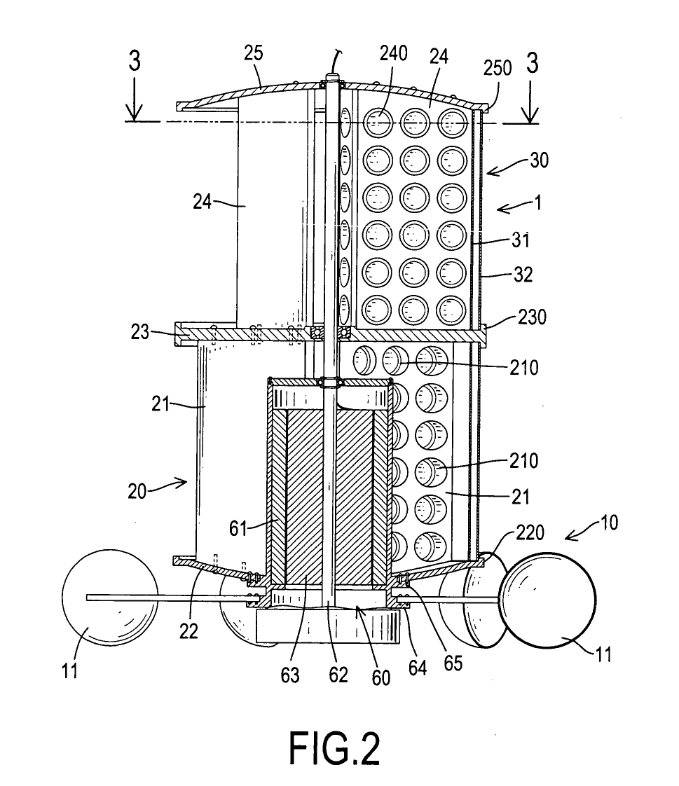

With reference to FIGS. 1 and 2, a wind-powered electricity generator in accordance with the present invention comprises a body (60), a rotor (61), an axle (62), a stator (63) and a fan assembly (1).

The body (60) may be tubular and has an outer surface, an inner surface, a chamber, an open end, a closed end, a through hole, a first supporting frame (64) and a second supporting frame (65). The chamber is defined inside the body (60). The through hole is formed in the closed end of the body (60) and communicates with the chamber. The first supporting frame (64) is formed around the outer surface of the body (60) near the open end. The second supporting frame (65) is formed around the outer surface of the body (60) over the first supporting frame (64).

The rotor (61) may be hollow and is mounted on the inner surface of the body (60). The axle (62) is connected to the body (60) and has a lower end and an upper end. The lower end of the axle (62) is defined in the chamber of the body (60) and the upper end extends outside the closed end of the body (60) through the through hole. The stator (63) is connected to the axle (62) inside the chamber of the body (60) and corresponds to the rotor (61).

With reference to FIGS. I to 3, the fan assembly (1) is connected to the body (60) of the wind-powered electricity generator and has a wind-ladle device (10), a blade device (20) and two covering devices (30).

The wind-ladle device (10) is attached to the body (60) and has multiple connecting shafts and multiple wind ladles (11). The connecting shafts are connected to the first supporting frame (64) and are arranged in a circle, and each connecting shaft has a proximal end and a distal end. The proximal end of each connecting shaft is connected to the first supporting frame (64) in the body (60) of the wind-powered electricity generator. In a preferred embodiment, the connecting shafts are connected to the first supporting frame (64) with multiple bolts extending through the proximal ends and the first supporting frame (64).

The wind ladles (11) are semispherical, are mounted respectively on the distal ends of the connecting shafts and each wind ladle (11) has a windward face formed inside the wind ladle (11).

The blade device (20) is connected to the body (60) of the wind-powered electricity generator and has a lower mounting plate (22), multiple blades (21), a middle mounting plate (23), multiple upper blades (24) and an upper mounting plate (25). The lower mounting plate (22) is connected to the second supporting frame (65) over the wind-ladle device (10) and has a center, a through hole, a top, a periphery and a flange (220). The through hole is formed through the center of the lower mounting plate (22) around the body (60) over the second supporting frame (65). The flange (220) is formed around and protrudes from the top of the lower mounting plate (22) at the periphery of the lower mounting plate (22).

The blades (21) are curved, are mounted on the top of the lower mounting plate (22), are connected to the body (60) and each blade (21) has a lower end, an upper end, an inner side, an outer side, a thickness, a windward face and multiple wind-store recesses (210). The lower end of the blade (21) is mounted on the top of the lower mounting plate (22). In a preferred embodiment, the blades (21) are mounted on the lower mounting plate (22) with multiple bolts extending through the lower mounting plate (22) and into the lower ends of the blades (21).

The inner side of the blade (21) is connected to the outer surface of the body (60). The outer side of the blade (21) is located near the flange (220) of the lower mounting plate (22). The thickness of the blade (21) is gradually increased from the inner side to the outer side at a ratio range of 1:1 to 1:3.

The windward face has a negative camber, is defined in the blade (21) and has a direction same as that of the windward faces of the wind ladles (11) in the wind-ladle device (10). The wind-store recesses (210) are formed in the negative cambers of the blades (21) and each wind-store recess (210) has a depth. The depths of the wind-store recesses (210) on each blade (21) are gradually increased and have a ratio same as that of the thickness of the blade (21) from the inner side to the outer side.

The middle mounting plate (23) is connected to the blades (21) and has a center, a through hole, a bottom, a top, a periphery and two flanges (230). The through hole is formed through the center of the middle mounting plate (23) and the axle (62) extends through the through hole. The bottom of the middle mounting plate (23) is connected to the upper ends of the blades (21). In a preferred embodiment, the middle mounting plate (23) is mounted on the blades (21) with multiple bolts extending through the middle mounting plate (23) and into the upper ends of the blades (21).

The flanges (230) are formed around and protruded up and down from the top and the bottom of the middle mounting plate (23), respectively. Then, the outer ends of the blades (21) are located between the flange (220) on the top of the lower mounting plate (23) and the flange (230) on the bottom of the middle mounting plate (23).

The upper blades (24) are mounted on the top of the middle mounting plate (23) and have a structure same as that of the blades (21) except that the shapes of the plates (23,24) are different. The upper blades (24) may be mounted on the middle mounting plate (23) with an alternate angle 30° relative to the blades (21).

Each upper blade (24) has a lower end, an upper end, an inner side, an outer side, a thickness, a windward face and multiple wind-store recesses (240). The lower end of the upper blade (24) is mounted on the top of the middle mounting plate (23). In a preferred embodiment, the upper blades (24) are mounted on the middle mounting plate (23) with multiple bolts extending through the middle mounting plate (23) and into the lower ends of the upper blades (24).

The inner side of the upper blade (24) is located near the through hole of the middle mounting plate (23). The outer side of the upper blade (24) is located near the flange (230) on the top of the middle mounting plate (23). The thickness of the upper blade (24) is gradually increased from the inner side to the outer side at a ratio same as that of the thickness of the blade (21). The windward face has a negative camber, is defined in the upper blade (24) and has a direction same as that of the windward faces of the wind ladles (11) of the wind-ladle device (10). The wind-store recesses (240) are formed in the negative cambers of the upper blades (24) and each wind-store recess (240) has a depth. The depths of the wind-store recesses (240) are gradually increased and have a ratio same as that of the thickness of the upper blade (24) from the inner side to the outer side.

The upper mounting plate (25) is connected to the upper blades (24) and has a structure substantially same as that of the lower mounting plate (22) and has a center, a through hole, a bottom, a periphery and a flange (250). The through hole is formed through the center of the upper mounting plate (25) and is connected to the axle (62). The bottom of the upper mounting plate (25) is connected to the upper ends of the upper blades (24). In a preferred embodiment, the upper mounting plate (25) is mounted on the upper blades (24) with multiple bolts extending through the upper mounting plate (25) and into the upper ends of the upper blades (24).

The flange (250) is formed around and protruded down from the bottom of the upper mounting plate (25). The outer end of the upper blade (24) is located between the flange (230) on the top of the middle mounting plate (23) and the flange (250) on the bottom of the upper mounting plate (25).

In a preferred embodiment, six blades (21) and six upper blades (24) are mounted between the mounting plates (22, 23, 25).

The covering devices (30) are connected to the blade device (20) between the mounting plates (22, 23, 25) and each covering device (30) has an inner coverings (31), an outer coverings (32) and a spring (33). The inner coverings (31) are semicircular, are connected respectively to some of the outer sides of the blades (21) and the upper blades (24) between the mounting plates (22, 23, 25) and each inner covering (31) has a connecting end.

The outer coverings (32) are semicircular, are mounted movably between the mounting plates (22, 23, 25), are aligned with the inner coverings (31) and contact with the flanges (220,230,250) of the mounting plates (22, 23, 25). Each outer covering (32) has a connecting end corresponding to the connecting end of a corresponding inner covering (31).

Each spring (33) is mounted between the corresponding outer covering (32) and inner covering (31) and has two ends. One of the ends of the spring (33) is connected to the connecting end of the outer covering (32) and the other end is connected to the connecting end of the corresponding inner covering (31).

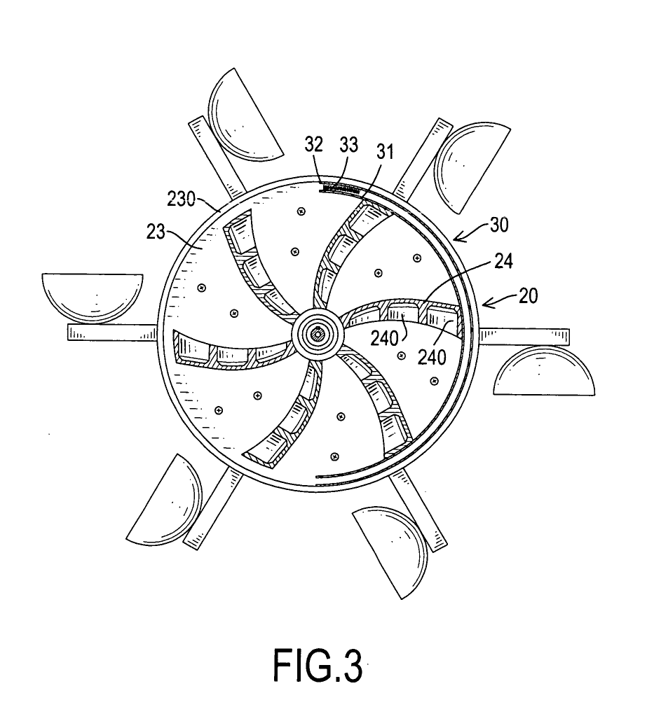

In a slight wind condition, with reference to FIGS. 2 and 3, the blades (21) and the upper blades (24) are rotated by wind flowing over the wind-store recesses (210, 240) to make the body (60) and rotor (61) rotating relative to the stator (63) to generate power. The inner coverings (31) are rotated with the blades (21) and the upper blades (24) and the outer coverings (32) between the mounting plates (22,23,25) are moved with the corresponding inner coverings (31) by the springs (33) pulling the outer coverings (32) with the corresponding inner coverings (31).

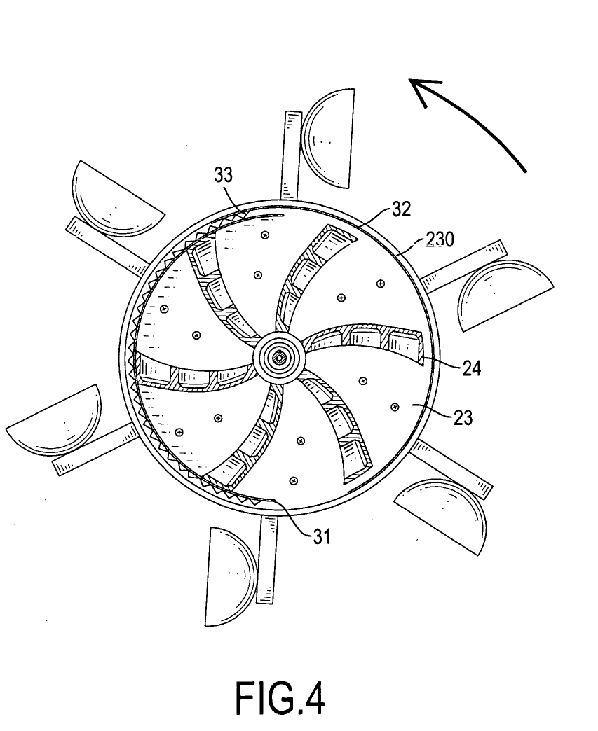

In a stiff wind condition, with reference to FIG. 4, the rotating speed of the blades (21) and the upper blades (24) will be increased by the wind speed of the stiff wind condition and the inner coverings (31) will rotate with the blades (21) and the upper blades (24) at a high speed. At the same time, the inner coverings (31) are moved with the blades (21) and the upper blades (24) relative to the corresponding outer coverings (32) between the mounting plates (22,23,25). Then, the outer coverings (32) and the corresponding inner coverings (31) will cover the blades (21) and the upper blades (24) inside the mounting plates (22, 23, 25) to prevent the blades (21) and the upper blades (24) from being broken by the stiff wind. When velocity of the wind slows down, the springs (33) will pull the outer coverings (32) moving to the corresponding inner coverings (31) to let the blades (21) and the upper blades (24) contacting with the wind.

The fan assembly (1) for a wind-powered electricity generator as described has the following advantages.

1. The blades (21) and the upper blades (24) are set inside the fan assembly (1) between the mounting plates (22,23,24) and the covering devices (30). Therefore, in a stiff wind condition, the outer coverings (32) and the inner coverings (31) will cover the blades (21) and the upper blades (24) inside the mounting plates (22, 23, 25) automatically to prevent the blades (21) and the upper blades (24) from being broken by the stiff wind.

2. The blades (21) and the upper blades (24) have multiple wind-store recesses (210, 240) to increase the contacting areas to store wind to push the blades (21) and the upper blades (24) rotating and this can increase the rotating speed of the blades (21) and the upper blades (24). In addition, the thicknesses of the blade (21) and the upper blade (24) are increased from the inner side to the outer side at a specific ratio, and the depths of the wind-store recesses (210, 240) have a ratio same as that of the thickness of the blade (21) and the upper blade (24), this will increase the efficiency of the wind-powered electricity generator.

3. The fan assembly (1) for a wind-powered electricity generator will not need a braking device or an electromagnetic device to slow down the rotating speed of the blades (21) and the upper blades (24). In a stiff wind condition, the covering devices (30) will cover the blades (21) and the upper blades (24) inside of the mounting plates (22, 23, 25) automatically to slow down the rotating speed and to prevent the blades (21,24) from being broken.

Even though numerous characteristics and advantages of the present invention have been set forth in the foregoing description, together with details of the structure and features of the utility model, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A wind-powered electricity generator having
a body having
an outer surface;
an inner surface;
a chamber being defined inside the body;
an open end;
a closed end;
a through hole being formed in the closed end of the body and communicated with the chamber;
a first supporting frame being formed around the outer surface of the body near the open end; and
a second supporting frame being formed around the outer surface of the body over the first supporting frame;
a rotor being mounted on the inner surface of the body;
an axle being connected to the body and having
a lower end being defined in the chamber of the body; and
an upper end being extended outside the closed end of the body through the through hole of the body;
a stator being connected to the axle inside the chamber of the body and corresponds to the rotor; and
the fan assembly being connected to the body and having
a wind-ladle device being attached the body and having multiple connecting shafts being connected to the first supporting frame and arranged in a circle and each connecting shaft having
a proximal end being connected to the first supporting frame in the body; and
a distal end; and
multiple wind ladles being semispherical, being mounted respectively on the distal ends of the connecting shafts and each wind ladle having
a windward face being formed inside the wind ladle;
a blade device being connected to the body and having
a lower mounting plate being connected to the second supporting frame over the wind-ladle device and having
a center;
a through hole being formed through the center of the lower mounting plate around the body over the second supporting frame; and
a top;
multiple blades being curved, being mounted on the lower mounting plate and being connected to the body and each blade having
a lower end being mounted on the top of the lower mounting plate;
an upper end;
an inner side being connected to the outer surface of the body;
an outer side;
a windward face having a negative camber, being defined in the blade with a direction same as the windward faces of the wind ladles in the wind-ladle device; and
multiple wind-store recesses formed in the negative cambers of the blades; and
a middle mounting plate being connected to the blades and having
a center;
a through hole being formed through the center of the middle mounting plate and the axle being extended through the through hole; and
a bottom being connected to the upper ends of the blades;
at least one covering device being connected to the blade device between the mounting plates and each covering device having
an inner coverings being semicircular, being connected to some of the outer sides of the blades between the mounting plates with a connecting end;
an outer coverings being semicircular, being mounted movably between the mounting plates and aligned with the inner coverings with a connecting end corresponding to the connecting end of the inner covering; and
a spring being mounted between the outer covering and the inner covering with two ends, one of the ends being connected to the connecting end of the outer covering and the other end being connected to the connecting end of the inner covering.

2. The wind-powered electricity generator as claimed in claim 1, wherein
the blade device further has
multiple upper blades being mounted on the top of the middle mounting plate and each upper blade having
a lower end being mounted on the top of the middle mounting plate;
an upper end being located near the through hole of the middle mounting plate;
an inner side being located near the through hole of the middle mounting plate;
an outer side;
a windward face having a negative camber, being defined in the upper baled with a direction same as the windward faces of the wind ladles in the wind-ladle device; and
multiple wind-store recesses being formed in the negative cambers of the upper blades; and
an upper mounting plate connected to the upper blades and having
a center;
a through hole being formed through the center of the upper mounting plate and being connected to the axle; and
a bottom being connected to the upper ends of the upper blades; and
a second covering device being connected to the blade device between the middle mounting plate and the upper mounting plate and having
an inner coverings being semicircular, being connected to some of the outer sides of the upper blades between the mounting plates with a connecting end;
an outer coverings being semicircular, being mounted movably between the mounting plates and aligned with the inner coverings with a connecting end corresponding to the connecting end of the inner covering; and
a spring being mounted between the outer covering and the inner covering with two ends, one of the ends being connected to the connecting end of the outer covering and the other end being connected to the connecting end of the inner covering.

3. The wind-powered electricity generator as claimed in claim 2, wherein
the lower mounting plate further has
a periphery; and
a flange being formed around and protruded from the top of the lower mounting plate at the periphery of the lower mounting plate;
the middle mounting plate further has
a top;
a periphery; and
two flanges being formed around and protruded up and down from the top and the bottom of the middle mounting plate;
the upper mounting plate further has
a periphery; and
a flange being formed around and protruded down from the bottom of the upper mounting plate;
the outer ends of the blade and the upper blade being located near the flanges of the mounting plates; and
the outer coverings being contacted with the flanges of the mounting plates.

4. The wind-powered electricity generator as claimed in claim 3, wherein
each blade has a thickness being gradually increased from the inner side to the outer side at a ratio as 1:1 to 1:3;
each wind-store recess of the blade has a depth being gradually increased with a ratio same as that of the thickness of the blade from the inner side to the outer side;
each upper blade has a thickness gradually being increased as the ratio of the thickness of the blade from the inner side to the outer side; and
each wind-store recess of the upper blade has a depth with the same ratio as the thickness of the upper blade from the inner side to the outer side.

5. The wind-powered electricity generator as claimed in claim 4, wherein the upper blades are mounted on the middle mounting plate with an alternate angle 30° relative to the blades.

6. The wind-powered electricity generator as claimed in claim 5, wherein
the connecting shafts of the wind-ladle device are connected to the first supporting frame with multiple bolts extending through the proximal ends and the first supporting frame;
the blades are mounted on the lower mounting plate with multiple bolts extending through the lower mounting plate and into the lower ends of the blades.
the middle mounting plate is mounted on the blades with multiple bolts extending through the middle mounting plate and into the upper ends of the blades;
the upper blades are mounted on the middle mounting plate with multiple bolts extending through the middle mounting plate and into the lower ends of the upper blades; and
the upper mounting plate is mounted on the upper blades with multiple bolts extending through the upper mounting plate and into the upper ends of the upper blades.

7. The wind-powered electricity generator as claimed in claim 6, wherein six blades and six upper blades are mounted between the mounting plates.
